(19) United States
(12) Patent Application Publication
(10) Pub. No.: US 2024/0189991 A1
(43) Pub. Date: Jun. 13, 2024

(54) AUTONOMOUS DRIVING ROBOT AND ARTICLE TRANSPORT METHOD USING THE SAME

(71) Applicant: Samsung Electronics Co., Ltd., Suwon-si (KR)

(72) Inventors: Gyeongdam Baek, Suwon-si (KR); Hyeonuk Kim, Suwon-si (KR); Byungkook Yoo, Suwon-si (KR); Seungjun Lee, Suwon-si (KR); Mingu Chang, Suwon-si (KR); Younboo Jung, Suwon-si (KR); Jaehyuk Cha, Suwon-si (KR); Jimin Choi, Suwon-si (KR); Sunoh Kim, Cheonan-si (KR); Kyeongjun Min, Cheonan-si (KR); Donghoon Yang, Cheonan-si (KR); Jiwon Yoon, Cheonan-si (KR); Seungjun Lee, Cheonan-si (KR); Insung Choi, Cheonan-si (KR)

(73) Assignees: Samsung Electronics Co., Ltd., Suwon-si (KR); SEMES CO., LTD., Cheonan-si (KR)

(21) Appl. No.: 18/528,515

(22) Filed: Dec. 4, 2023

(30) Foreign Application Priority Data
Dec. 9, 2022 (KR) 10-2022-0171864

(51) Int. Cl. B25J 9/16; B25J 9/00

(52) U.S. Cl. CPC B25J 9/162; B25J 9/0009; B25J 9/1682

(57) ABSTRACT

An autonomous driving robot includes a storage unit including a housing, which provides a space for storing an article, and a shelf which is provided inside the housing and on which the article is loaded, a manipulator including a linear actuator, and a selective compliance articulated robot arm, which is coupled to the linear actuator, and a transport unit coupled to the storage unit, wherein a plurality of shelves are provided, some of the shelves are provided adjacent to one inner wall of the housing and spaced apart from each other in the vertical direction, and the other shelves are provided adjacent to another inner wall which faces the one inner wall and spaced apart from each other in the vertical direction, and the plurality of shelves extend toward a central portion of the housing, but extend to a point before reaching the central portion of the housing.

### CROSS-REFERENCE TO RELATED APPLICATION

This application is based on and claims priority under 35 U.S.C. § 119 to Korean Patent Application No. 10-2022-0171864, filed on Dec. 9, 2022, in the Korean Intellectual Property Office, the disclosure of which is incorporated by reference herein in its entirety.

### BACKGROUND

The inventive concept relates to an autonomous driving robot and an article transport method using the same, and more particularly, to an autonomous driving robot having an improved transport efficiency and an article transport method using the same.

During production processes of semiconductor products, hundreds of processes are performed until finished products are obtained. Also, hundreds of thousands of flow of articles occur during semiconductor manufacturing processes. In order to prevent contamination, damage, and delivery accidents of semiconductor materials during the article transport processes, autonomous driving robots are utilized as article transport automation system in semiconductor manufacturing lines.

The autonomous driving robots include overhead hoist transfer (OHT), automated guided vehicles (AGV), autonomous mobile robots (AMR), and the like. However, the efficiency of transporting articles using the autonomous driving robots is becoming an issue.

### SUMMARY

Aspects of the inventive concept provide an autonomous driving robot having an improved transport efficiency and an article transport method using the same.

The objects of the inventive concept are not limited to the aforementioned object, but other objects not described herein will be clearly understood by those skilled in the art from the following description.

Aspects of the inventive concept provide an autonomous driving robot described below. According to an aspect of the inventive concept, there is provided an autonomous driving robot including a storage unit including a housing, which provides a space for storing an article, and a shelf which is provided inside the housing and configured such that the article is loaded on the shelf, a manipulator including a linear actuator which is provided inside the housing and extends in a vertical direction, and a selective compliance articulated robot arm (SCARA arm), which is coupled to the linear actuator, and a transport unit coupled to the storage unit and configured to move the storage unit, wherein a plurality of shelves are provided in the storage unit, some of the shelves are provided adjacent to one inner wall of the housing and spaced apart from each other in the vertical direction, and the other shelves are provided adjacent to another inner wall which faces the one inner wall and spaced apart from each other in the vertical direction, and wherein the plurality of shelves extend in a horizontal direction toward a central axis of the housing, the central axis extending vertically at a center of the housing, and the plurality of shelves do not vertically overlap the central axis of the housing.

According to another aspect of the inventive concept, there is provided an autonomous driving robot including a storage unit including a housing, which provides a space for storing an article, and a shelf which is provided inside the housing and configured such that the article is loaded on the shelf, a manipulator including a linear actuator, which is provided inside the housing and extends in a vertical direction, and a selective compliance articulated robot arm (SCARA arm), which is coupled to the linear actuator, and a transport unit coupled to a bottom surface of the storage unit and configured to move on a floor, wherein a plurality of shelves are provided in the storage unit, some of the shelves are provided adjacent to one inner wall of the housing and spaced apart from each other in the vertical direction, and the other shelves are provided adjacent to another inner wall which faces the one inner wall and spaced apart from each other in the vertical direction, and the plurality of shelves extend horizontally toward a central axis of the housing, the central axis extending vertically at a center of the housing, and the plurality of shelves co not vertically overlap the central axis of the housing, wherein the SCARA arm includes at least two horizontal joints.

In order to achieve the above object, aspects of the inventive concept provide an article transport method described below.

According to another aspect of the inventive concept, there is provided an article transport method including transmitting an operation instruction signal from a central control system to an autonomous driving robot, wherein the autonomous driving robot transmits a response signal to the central control system in response to the operation instruction signal, moving the autonomous driving robot to a manual port of a stocker, and starting loading or unloading of an article by the autonomous driving robot, wherein the autonomous driving robot includes a storage unit including a housing, which provides a space for storing an article, and a shelf, which is provided inside the housing and on which the article is loaded, a manipulator including a linear actuator, which is provided inside the housing and extends in a vertical direction, and a selective compliance articulated robot arm (SCARA arm), which is coupled to the linear actuator, and a transport unit coupled to a bottom surface of the storage unit and configured to move on a floor, wherein the SCARA arm includes at least two horizontal joints.

### BRIEF DESCRIPTION OF THE DRAWINGS

Embodiments will be more clearly understood from the following detailed description taken in conjunction with the accompanying drawings in which:

FIG. 1 is a perspective view schematically showing an autonomous driving robot according to some embodiments;

FIG. 2 is a perspective view schematically showing a transport unit of the autonomous driving robot of FIG. 1;

FIG. 3A is a perspective view schematically showing a storage unit of the autonomous driving robot of FIG. 1;

FIG. 3B is a front view schematically showing a storage unit of the autonomous driving robot of FIG. 1;

FIG. 3C is a perspective view schematically showing a shelf of the storage unit of FIGS. 3A and 3B;

FIG. 3D is a perspective view schematically showing an embodiment of an article loaded on the shelf of FIG. 3C;

FIG. 4 is a perspective view schematically showing a manipulator of the autonomous driving robot of FIG. 1;

FIG. 5 is a flowchart showing an article transport method according to an embodiment of the inventive concept;

FIG. 6 is a schematic view schematically showing a manufacturing line in which an autonomous driving robot according to some embodiments is applied;

FIG. 7 is a block diagram schematically showing a method of controlling an autonomous driving robot, according to some embodiments;

FIGS. 8A and 8B are schematic views for describing a method of transporting an article, according to some embodiments of the inventive concept; and

FIGS. 9A to 9E are schematic views for describing an article loading and unloading method by an autonomous driving robot according to some embodiments of the inventive concept.

### DETAILED DESCRIPTION OF THE EMBODIMENTS

Hereinafter, embodiments are described in detail with reference to the accompanying drawings. The same reference numerals are used for the same elements in the drawings, and redundant/duplicated descriptions thereof are omitted.

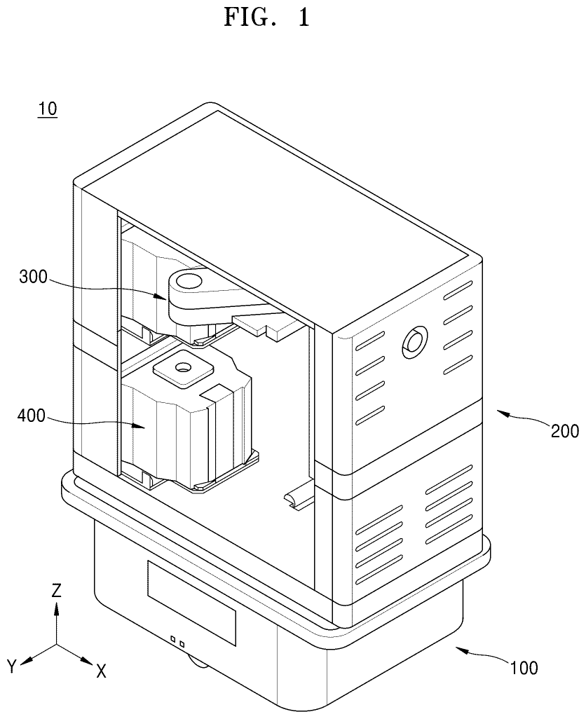

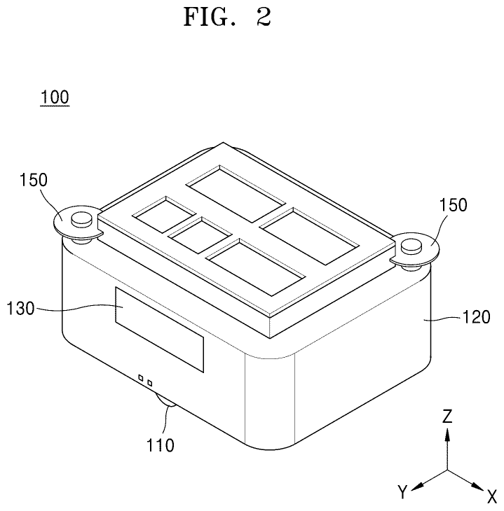

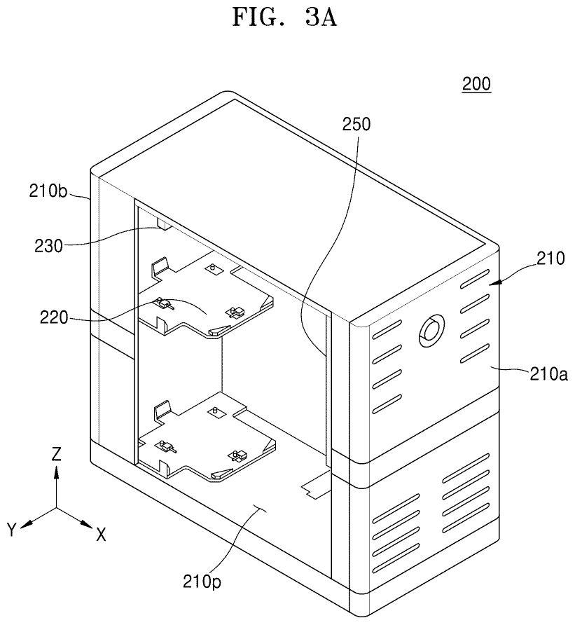

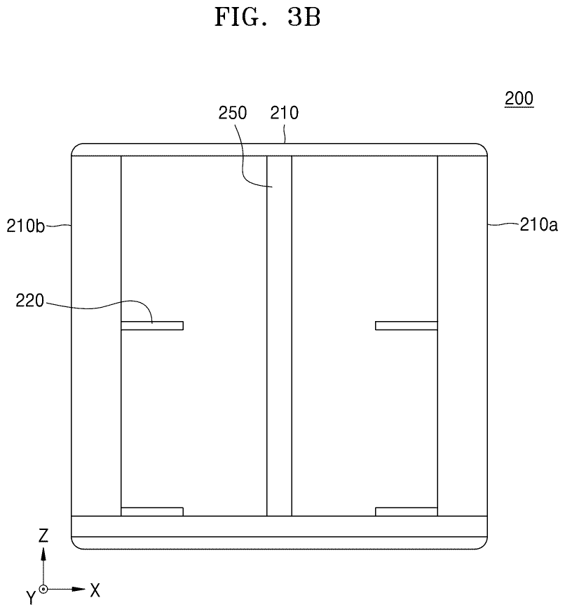

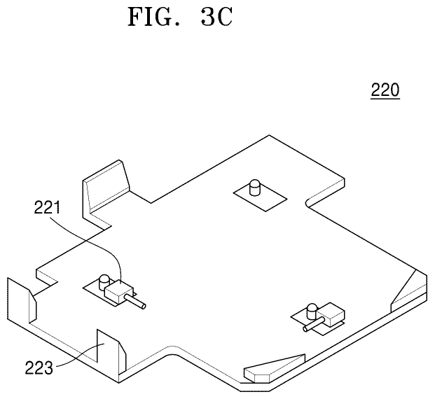

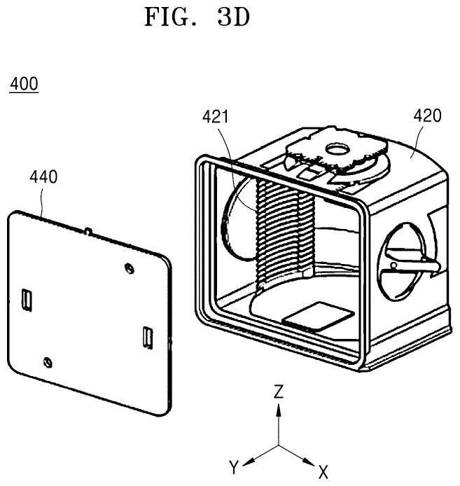

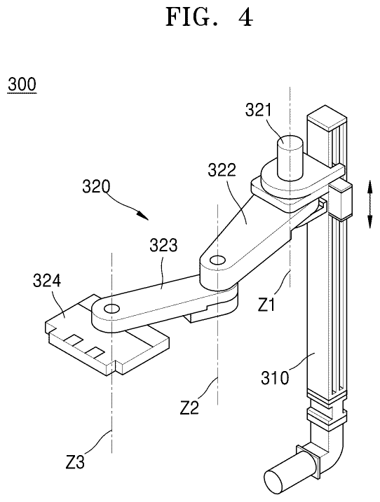

FIG. 1 is a perspective view schematically showing an autonomous driving robot according to some embodiments. FIG. 2 is a perspective view schematically showing a transport unit of the autonomous driving robot of FIG. 1. FIG. 3A is a perspective view schematically showing a storage unit of the autonomous driving robot of FIG. 1. FIG. 3B is a front view schematically showing a storage unit of the autonomous driving robot of FIG. 1. FIG. 3D is a perspective view schematically showing an article loaded on a shelf of FIG. 3C according to an embodiment. FIG. 4 is a perspective view schematically showing a manipulator of the autonomous driving robot of FIG. 1.

Referring to FIGS. 1 to 4, an autonomous driving robot 10 may include a transport unit (e.g., a transporter) 100, a storage unit (e.g., a storage) 200, and a manipulator 300. The autonomous driving robot 10 may include or may be an autonomous mobile robot (AMR), but the embodiment is not limited thereto. The autonomous driving robot 10 may include or may be an automated guided vehicle (AGV) and an overhead hoist transfer (OHT). The autonomous driving robot 10 is illustrated similarly to the shape of the AMR in FIGS. 1 to 4, but the embodiment is not limited thereto. The autonomous driving robot 10 may include or may be the AGV, the OHT, and/or another autonomous driving robot as described above, and the autonomous driving robot 10 may be any robot that loads and conveys an article to another place.

Here, OHT, AGV, and AMR are all unmanned driving robots. The OHT may include or may be a transfer robot configured to be movable along a running rail installed on a ceiling of a fab to transport articles. The AGV may include or may be a transfer robot configured to be movable along a line installed on a floor to transport articles and may be moved along the installed line by an electromagnetic induction method, an optical tape method, or a magnetic tape method. The AMR may include a transport vehicle configured to be movable on the ground/floor to transport articles and include a robot capable of recognizing and avoiding obstacles and moving without being limited to a predefined fixed path.

Also, here, an article 400 may include or may be a carrier, on which substrates are loaded, such as a front open shipping box (FOSB) or a front open unified pod (FOUP).

Referring to FIGS. 1 and 2, the transport unit 100 may be coupled to a lower surface (e.g., a bottom surface) of the storage unit 200. The transport unit 100 may be configured to transport the storage unit 200. The transport unit 100 may be configured to move along/on the ground/floor while supporting the storage unit 200 having a certain weight.

The transport unit 100 may include a wheel 110, a body 120, a charging pad 130, and a lidar 150. The wheel 110 may be coupled to a lower portion (e.g., bottom) of the body 120. The wheel 110 may include or may be a means for moving the transport unit 100 along/on the ground/floor. The wheel 110 may include a motor and a speed reducer. For example, the transport unit 100 may include a motor and a speed reducer to control the wheel and/or the movement of the transport unit 100. The motor may provide power to the speed reducer, and the speed reducer may convert the power into appropriate torque and rotational speed and provide the same to the wheel 110. In some embodiments, the speed reducer may include or may be a right angle-type speed reducer and enhance utilization of a space below the transport unit 100.

The wheel 110 may be coupled to the lower surface (e.g., the bottom surface) of the body 120. According to some embodiments, three pairs of wheels 110 may be provided on the lower/bottom surface of the body 120. The wheels 110 may include a pair of driving wheels, which are located at the center of the lower/bottom surface of the body 120 and receive rotational force directly from the motor and the speed reducer; and two pairs of auxiliary wheels, which are located on the outside of the lower/bottom surface of the body 120 and provided on the front and rear sides in a direction in which the driving wheels and the transport unit 100 move. For example, the driving wheels may receive driving power from the motor and/or the speed reducer, and the auxiliary wheels may roll by friction between the auxiliary wheels and the floor. At least some of the plurality of wheels may include steering wheels that change or maintain a traveling direction of the transport unit 100.

In the following drawings, an X-axis direction and a Y-axis direction may represent directions parallel to the upper/top or lower/bottom surface of the body 120, and the X-axis direction and the Y-axis direction may be perpendicular to each other. A Z-axis direction may represent a direction perpendicular to the upper/top or lower/bottom surface of the body 120. For example, the Z-axis direction may be a direction perpendicular to the X-Y plane.

Also, in the following drawings, a first horizontal direction, a second horizontal direction, and a vertical direction may be understood as follows. The first horizontal direction may be understood as the X-axis direction, the second horizontal direction may be understood as the Y-axis direction, and the vertical direction may be understood as the Z-axis direction.

The body 120 may be coupled to the lower/bottom surface of the storage unit 200. For example, the upper/top surface of the body 120 may be configured to be coupled to the storage unit 200. For example, a protrusion may be formed on the upper/top surface of the body 120. The protrusion may be coupled to a recess formed in the lower/bottom surface of the storage unit 200. For example, the top and bottom surfaces of the body 120 and the storage unit 200 may be parallel to a horizon plane. The body 120 has a rectangular parallelepiped shape or an approximately rectangular parallelepiped shape, and corners of the rectangular parallelepiped, which extend in the vertical direction Z, may have rounded shapes. For example, the body 120 may have a rectangular parallelepiped shape in which the four corners of the rectangular parallelepiped, which extend in the vertical direction, are finished with chamfers. However, the shape of the body 120 is not limited thereto.

The charging pad 130 may be provided on one side surface of the body 120. The charging pad 130 may be configured to charge a battery provided in the body 120. According to some embodiments, the charging pad 130 may include a wireless power receiver. Accordingly, the charging pad 130 may wirelessly charge the battery.

The lidar 150 may be coupled to the body 120. The lidar 150 may be configured to detect obstacles when the transport unit 100 travels. In some embodiments, the lidar 150 may operate in a 2-dimensional scanning method. The lidar 150 may transmit a laser signal to the vicinity of the autonomous driving robot 10 and analyze the signal reflected therefrom, thereby detecting position coordinates of nearby obstacles. The lidar 150 may detect the location of an obstacle in a narrow space, such as an elevator or a narrow passageway, and may detect a region (area) in which the autonomous driving robot 10 moves while avoiding a collision with the obstacle.

According to some embodiments, the transport unit 100 may further include an auxiliary sensor unit. The auxiliary sensor unit includes at least one of a 3D camera, a quick response (QR) reader, a distance sensor, and a laser unit, and may assist in detecting the surrounding environment for autonomous driving and generate location information suitable for a factory map coordinate system. The distance sensor may generate a map and a coordinate system thereof by a simultaneous localization and mapping (SLAM) method. In addition, real-time location information may be measured using at least one of high-precision differential global positioning system (DGPS), triangulation using a plurality of APs, or path planning.

Referring to FIGS. 1, 3A, and 3B, the storage unit 200 may be provided on the upper/top surface of the transport unit 100. The storage unit 200 may include a housing 210, a shelf 220, and a first detection sensor 230. The housing 210 has an empty space therein and may be open on one side. The article 400 may be accommodated in the empty space inside the housing 210. According to some embodiments, the housing 210 may have a rectangular parallelepiped shape, but is not limited thereto.

According to some embodiments, the housing 210 may have an opening 210p on one side of the housing 210 so that the article 400 is carried in or taken out of the housing 210. In some embodiments, the opening 210p may be formed in one of the pair of side surfaces having a large cross-sectional area among the two pairs of side surfaces of the housing 210. For example, the opening 210p may be formed on in of the pair of side surfaces having a large cross-sectional area among four side surfaces of the housing 210 that has a substantially rectangular parallelepiped shape. Therefore, the housing 210 may have substantially three side walls. In this case, the cross-sectional area of a side wall, which faces the opening 210p, may be larger than the cross-sectional area of each of the two side walls of the housing 210 perpendicular to the side wall. In the same sense, the cross-sectional area of each of the two side walls perpendicular to the opening 210p may be smaller than the cross-sectional area of a side wall perpendicular to each of the two side walls. Here, two side walls perpendicular to the opening 210p, for example, two side walls having a smaller cross-sectional area among the three side walls of the housing 210, may be defined as first side walls 210a and 210b. For example, the housing 210 may have a rectangular parallelepiped shape having six faces including top, bottom and four side faces. Among the four side faces, a first pair of the side faces opposite each other may have smaller areas than a second pair of side faces opposite each other, and the opening 210p may be formed in one of the second pair of side faces of the rectangular parallelepiped shape of the housing 210.

The housing 210 may further include a coupling member 250 formed at a central portion thereof. The coupling member 250 may be configured to fix the manipulator 300 to the inside of the housing 210. According to some embodiments, the coupling member 250 may be configured to be coupled to a linear actuator 310 (see FIG. 4) of the manipulator 300.

In some embodiments, the coupling member 250 may include a frame extending in the vertical direction Z. The frame is located on the inner surface of the side wall having the largest area/cross-section among the three side walls of the housing 210 and may be coupled to the manipulator 300. According to some embodiments, the frame may be coupled to the linear actuator of the manipulator 300. In some embodiments, the coupling member 250 may have a groove that is formed in the lower/bottom surface of the housing 210. Here, the manipulator 300 may be inserted into the groove and fixed inside the housing 210. According to some embodiments, the linear actuator of the manipulator 300 may be inserted into the groove, and thus, the manipulator 300 may be fixed inside the housing 210.

The shelf 220 may be provided inside the housing 210. The article 400 may be loaded on the shelf 220. According to some embodiments, a plurality of shelves 220 may be provided. The plurality of shelves 220 may be provided adjacent to one inner wall of the housing 210 and another inner wall that faces the one inner wall.

According to some embodiments, some of the plurality of shelves 220 may be provided on the inner surface of a first side wall 210a, and the other shelves 220 may be provided on the inner surface of a first side wall 210b that faces the first side wall 210a. Accordingly, the shelves 220 may be provided adjacent to the inner surfaces of the two side walls having a small area/cross-sectional area among the three side walls of the housing 210, that is, the first side walls 210a and 210b.

The shelf 220 may have a flat plate shape extending in a first horizontal direction X. Here, the shelf 220 may extend, in the first horizontal direction X, only to a point before reaching the central portion of the housing 210. For example, the length of the shelf 220 in the first horizontal direction X may be less than a half of the length of the housing 210 in the first horizontal direction X. Therefore, the shelf 220 provided adjacent to the inner surface of the first side wall 210a of the housing 210 may not extend to the first side wall 210b that faces the first side wall 210a. For example, the shelf 220 may not overlap a central axis of the housing 210 extending in a vertical direction at a center of the housing 210.

Accordingly, an empty space may be formed between the shelves 220 which are provided adjacent to the inner surfaces of the facing first side walls 210a and 210b of the housing 210, e.g., the empty space may be formed between the shelves 220 that face each other in the first horizontal direction X. Consequently, an empty space may be formed in the central portion of the housing 210. The manipulator 300 may be provided in the empty space as described below.

According to some embodiments, the shelves 220 may be attached to or detached from the inner walls. Also, according to some embodiment, the shelves 220 may be integrally coupled with the inner walls.

The shelves 220 provided on one inner wall of the housing 210 may have a multi-level configuration. For example, some of the plurality of shelves 220 may be provided on one inner wall of the housing 210 and spaced apart from each other in the vertical direction Z, and the other shelves 220 may be provided on another inner wall, which faces the one inner wall, and spaced apart from each other in the vertical direction Z.

According to some embodiments, some of the plurality of shelves 220 may be provided on the inner surface of the first side wall 210a and spaced apart from each other in the vertical direction Z, and the other shelves 220 may be provided on the inner surface of the first side wall 210b, which faces the first side wall 210a, and spaced apart from each other in the vertical direction Z.

According to some embodiments, a total of four shelves 220 are provided in the housing 210. Two of the shelves may be provided on one inner wall of the housing 210, and the other two shelves may be provided on another inner wall that faces the one inner wall. In this case, the two shelves 220 provided on the one inner wall may be spaced apart from each other in the vertical direction Z. Therefore, an empty space may be formed between the two shelves 220 in the vertical direction Z. Also, as described above, the shelves 220 extend in the first horizontal direction X, but extend to a point in front of the central portion inside the housing 210. Accordingly, an empty space may be formed between the shelves 220 that face each other in the first horizontal direction X.

The first detection sensor 230 may be located above each of the shelves 220. A plurality of first detection sensors 230 may be provided, and the number of first detection sensors 230 may be the same as the number of shelves 220. According to some embodiments, the first detection sensor 230 may be provided on an inner wall of the housing 210 adjacent to the shelf 220. The first detection sensor 230 may be spaced apart from the upper surface of the shelf 220 by a certain/predetermined distance in the vertical direction Z and provided on the inner wall of the housing 210. Here, the distance at which the first detection sensor 230 is spaced apart from the shelf 220 in the vertical direction Z may be less than the length of the article 400 in the vertical direction Z. Accordingly, when the article 400 is loaded on the shelf 220, the first detection sensor 230 may overlap the side wall of the article 400 in the first horizontal direction X. For example, when the article 400 is loaded on the shelf 220, the first detection sensor 230 may be covered by the article 400.

Referring to FIGS. 1 and 3C, the shelf 220 may have a T-shaped flat plate. For example, in a rectangle extending in a second horizontal direction Y, a protrusion protruding from the center of the rectangle in the first horizontal direction X may be formed. For example, the shelf 220 may include a first portion extending lengthwise in the second horizontal direction (Y direction), and the shelf 220 may include a second portion protruding from a middle of the first portion and extending in the first horizontal direction (X-direction). However, the embodiment is not limited thereto, and the shelf 220 may have any shape on which the article 400 is loaded.

The shelf 220 may include a second detection sensor 221 which is located on a surface in contact with the article 400, e.g., on the upper surface of the shelf 220. The second detection sensor 221 may be configured to detect a position at which the article 400 is disposed on the shelf 220. Therefore, the second detection sensor 221 may check whether the article 400 is placed at a correct position on the shelf 220. According to some embodiments, a plurality of second detection sensors 221 may be provided. Here, the plurality of second detection sensors 221 are provided along a virtual triangle on the upper surface of the shelf 220, and may be located at positions respectively corresponding to vertices of the triangle.

The shelf 220 may include a fixing member 223 that is formed on the upper surface of the shelf 220. The fixing member 223 may have a shape that protrudes from the upper surface of the shelf 220 in the vertical direction Z.

The shelf 220 may have a design structure that includes vibration-proof polymer. Accordingly, the shelf 220 is beneficial to minimize transmission of vibration, which is generated while the autonomous driving robot 10 travels, to the article 400.

According to some embodiments, the article 400 loaded on the shelf 220 may include or may be an FOUP.

Referring to FIG. 3D, the article 400 may include or may be a carrier that accommodates semiconductor substrates such as wafers. The article 400 may include or may be a sealed container for protecting the substrates from foreign substances or chemical contamination in the atmosphere.

The article 400 may include a body 420, which has a space with one surface opened, and a door 440, which opens and closes the body 420. A plurality of slots 421, into each of which a portion of an edge of a substrate is inserted, may be provided in an inner wall of the body 420. The slots 421 may be spaced apart from each other in the vertical direction Z by a certain/predetermined distance and provided on the inner wall of the body 420. The body 420 may have a material and/or structure optimized for extreme cleanliness.

A plate spring may be installed on an inner wall of the door 440 so that a certain/predetermined pressure is applied to the substrates loaded on the article 400 when the door 440 is closed.

Referring to FIGS. 1 and 3A to 3D, the article 400 may be placed on the shelf 220 such that the door 440 faces the first side wall 210a or 210b adjacent thereto. For example, each of the articles 400 loaded on the plurality of shelves 220 located adjacent to the first side wall 210a may be placed such that the door 440 faces the first side wall 210a. Similarly, each of the articles 400 loaded on the plurality of shelves 220 located adjacent to the first side wall 210b may be placed such that the door 440 faces the first side wall 210b. Therefore, the shelf 220 may be provided in the housing 210 such that the door 440 of the article 400 faces the first side wall 210a or 210b. For the shelf 220 according to some embodiments, the length of the shelf 220 in the first horizontal direction X may be less than the length of the shelf 220 in the second horizontal direction Y.

Referring to FIGS. 1 and 4, the manipulator 300 may be located inside the storage unit 200. The manipulator 300 may be provided in an empty space of the storage unit 200. As described above with reference to FIGS. 3A to 3D, the manipulator 300 may be provided in the empty space formed inside the housing 210 of the storage unit 200. As described above, the empty space may include or may be a space formed by the shape and arrangement of the shelves 220, e.g., a space between the slaves 220.

The manipulator 300 may include a linear actuator 310 and a selective compliance articulated robot arm (SCARA arm) 320. The linear actuator 310 may have a shape extending in the vertical direction Z. The linear actuator 310 may include a laminated piezoelectric actuator, a voice coil motor, and a rack and pinion actuator coupled to the voice coil motor.

The SCARA arm 320 may have a configuration in which a plurality of robot arms rotate on the X-Y plane. The SCARA arm 320 may include the arms that operate horizontally. The SCARA arm 320 may have at least two rotation axes that extend in a vertical direction. In the same sense, the SCARA arm 320 may have at least two joints that rotate on the X-Y plane. As the SCARA arm 320 has the at least two joints, the SCARA arm 320 may move a hand 324 to desired coordinates within a certain/predetermined radius on the X-Y plane.

The SCARA arm 320 may be coupled to the linear actuator 310. The SCARA arm 320 may be driven in the vertical direction Z by the linear actuator 310.

The SCARA arm 320 may include a first arm 322, a second arm 323, a connection member (e.g., a connector) 321, and a hand 324. The first arm 322 may be coupled to the linear actuator 310. The first arm 322 may be coupled to the linear actuator 310 by the connection member (connector) 321. The first arm 322 may be coupled to a slide that is driven in the vertical direction Z in the linear actuator 310. Here, one end of the first arm 322 may be coupled to the slide. The first arm 322 may be coupled to the slide of the linear actuator 310 by the connection member (connector) 321. Accordingly, the first arm 322 may be driven in the vertical direction Z by the linear actuator 310.

A first axis Z1 may be located in a region where the first arm 322 is coupled to the linear actuator 310 by the connection member (connector) 321. The first axis Z1 may include or may be an axis extending in the vertical direction Z, and the first arm 322 may rotate about the first axis Z1 on the X-Y plane. Consequently, one end of the first arm 322 is coupled and fixed to the linear actuator 310, and the first arm 322 may be rotated on the X-Y plane about the first axis Z1 formed at the one end. For example, the first arm 322 may rotate on the X-Y plane about the first axis Z1 that is located at the one end coupled to the linear actuator 310. A region, in which the first arm 322 and the linear actuator 310 are coupled to each other, may correspond to or may be a horizontal joint of the robot.

The first arm 322 may have a bar shape extending in the horizontal direction. According to some embodiments, a horizontal cross-section of the first arm 322 may have a horizontally long oval shape, and a vertical cross-section of the first arm 322 may have a rectangular shape. For example, the first arm 322 may have an oval shape in a plan view, bottom and top surfaces of the first arm 322 may be parallel to a horizontal plane, and side surfaces of the first arm may be parallel to a vertical line. For example, side surfaces along all around the first arm 322 may be parallel to a vertical line.

The second arm 323 may be coupled to the first arm 322. The second arm 323 may be coupled to the other end of the first arm 322. One end of the second arm 323 may be coupled to the other end of the first arm 322. Accordingly, one end of the first arm 322 may be coupled to the slide of the linear actuator 310, and the other end of the first arm 322 on the opposite side/end from the one end may be coupled to one end of the second arm 323.

The one end of the second arm 323 may be coupled to the lower/bottom surface or the upper/top surface of the other end of the first arm 322. A second axis Z2 may be located in a region where the second arm 323 and the first arm 322 are coupled to each other. The second arm 323 may rotate about the second axis Z2 on the X-Y plane. As the one end of the second arm 323 is coupled to the lower/bottom surface or the upper/top surface of the other end of the first arm 322, the second arm 323 may overlap the first arm 322 in the vertical direction Z while rotating about the second axis Z2. For example, as the one end of the second arm 323 is coupled to the lower/bottom surface or the upper/top surface of the other end of the first arm 322, the second arm 323 may not collide with the first arm 322 while rotating. Consequently, as the one end of the second arm 323 is coupled to the lower/bottom surface or the upper/top surface of the other end of the first arm 322, the second arm 323 may rotate 360 degrees on the X-Y plane.

Regarding the rotation about the second axis Z2, one end of the second arm 323 coupled to the first arm 322 may be fixed, but the other end of the second arm 323 on the opposite side/end from the one end may rotate about the one end (e.g., the second axis Z2) on the X-Y plane. A region, in which the first arm 322 and the second arm 323 are coupled to each other, may correspond to or may be a horizontal joint of the robot.

The hand 324 may be coupled to the other end of the second arm 323 on the opposite side/end from the one end. Therefore, one end of the second arm 323 may be coupled to the first arm 322, and the other end of the second arm 323 on the opposite side/end from the first arm 322 may be coupled to the hand 324.

The hand 324 may be coupled to the lower/bottom surface of the second arm 323. A third axis Z3 may be located in a region where the second arm 323 and the hand 324 are coupled to each other. The hand 324 may rotate about the third axis Z3 on the X-Y plane.

The first arm 322 may rotate about the first axis Z1 on the X-Y plane. Therefore, the other end of the first arm 322 having a certain/predetermined distance from the first axis Z1 may move, on the X-Y plane, in a circle centered at the one end of the first arm 322. Here, the one end of the second arm 323 may be coupled to the other end of the first arm 322. As the first arm 322 rotates about the first axis Z1, the second arm 323 may entirely rotate in a circle on the X-Y plane about the first axis Z1. Also, the second arm 323 may rotate again about the second axis Z2. For example, the second arm 323 may rotate in a circle on the X-Y plane while a portion of the second arm 323, in which the second axis Z2 is located, is fixed. Here, the coordinates of the second axis Z2 on the X-Y plane may be changed by the rotation about the first axis Z1. Therefore, the other end of the second arm 323 may move to desired coordinates on the X-Y plane without being limited to a circle. Also, since the other end of the second arm 323 moves to desired coordinates on the X-Y plane, the hand 324 coupled to the other end of the second arm 323 may also move to desired coordinates on the X-Y plane.

The first arm 322 may move in the vertical direction Z by the linear actuator 310, and thus, the second arm 323 coupled to the first arm 322 and the hand 324 coupled to the second arm 323 may also move in the vertical direction Z by the linear actuator 310. Accordingly, the hand 324 may move to desired coordinates in a space formed by the X, Y, and Z axes.

The hand 324 may further include a gripper. The gripper may be located on a lower/bottom surface of the hand 324. The gripper may be configured to be coupled to or detached from the article 400. For example, the hand 324 may hold or release the article 400 by using the gripper. The gripper may be coupled to or detached from the article 400 at a docking portion of the article 400. Accordingly, the gripper of the hand 324 is moved to correspond to the docking portion of the article 400, and the hand 324 may pick up the article 400.

The hand 324 may rotate about the third axis Z3 on the X-Y plane as described above. As the hand 324 rotates about the third axis Z3 on the X-Y plane, the gripper of the hand 324 may accurately move to a position corresponding to the docking portion of the article 400.

In the autonomous driving robot 10 according to some embodiments of the inventive concept, the shelves 220 may be arranged adjacent to the first side walls 210a and 210b in the storage unit 200, and the shelves 220 may have a multi-layer configuration. Also, since the shelves 220 do not extend to a central region of the housing 210, an empty space may be formed in the central region of the housing 210. For example, it is possible to load a plurality of articles 400 into the storage unit 200 while maximizing the empty space by the arrangement of the shelves 220.

Also, the manipulator 300 may be provided in the empty space. In addition, the manipulator 300 includes the linear actuator 310 and the SCARA arm 320 coupled to the linear actuator 310, and thus may move to desired coordinates in the space formed by the X, Y, and Z axes as described above. Furthermore, the driving method of the SCARA arm 320 may move the hand 324 to desired coordinates and prevent the first arm 322 and the second arm 323 from occupying unnecessary spaces. This is possible because the first arm 322 and the second arm 323 may overlap each other in the vertical direction Z during a driving process when the hand 324 is moved to desired coordinates.

Consequently, the autonomous driving robot 10 may load and convey a plurality of articles 400 while the manipulator 300 is provided in the storage unit 200. For example, the autonomous driving robot 10 may convey a plurality of articles 400 while occupying as little space as possible. Therefore, even when a passage connecting manufacturing equipment is narrow or a ceiling is low, the autonomous driving robot 10 may move along the passage while a plurality of articles 400 are loaded thereon. In addition, compared to another autonomous driving robot having the same size, the number of articles 400 to be conveyed at a time may be increased, and ultimately, the efficiency of conveying the articles 400 may be maximized.

In addition, it is possible to obtain the above-described effects by simply optimizing a structure without changing an existing infrastructure.

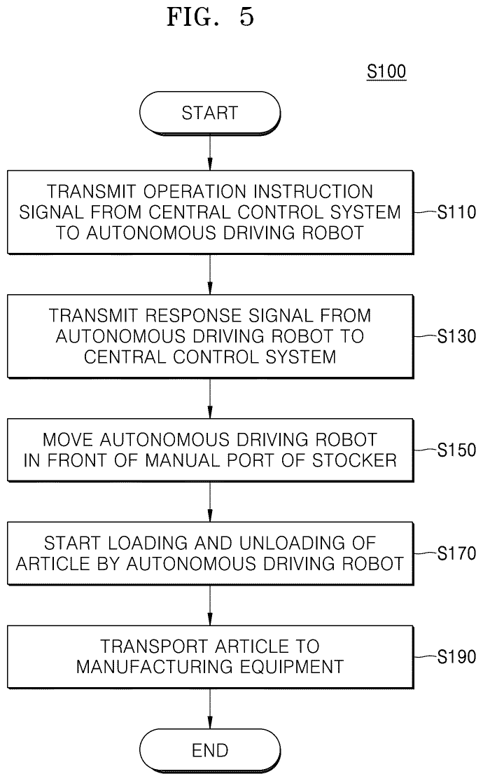

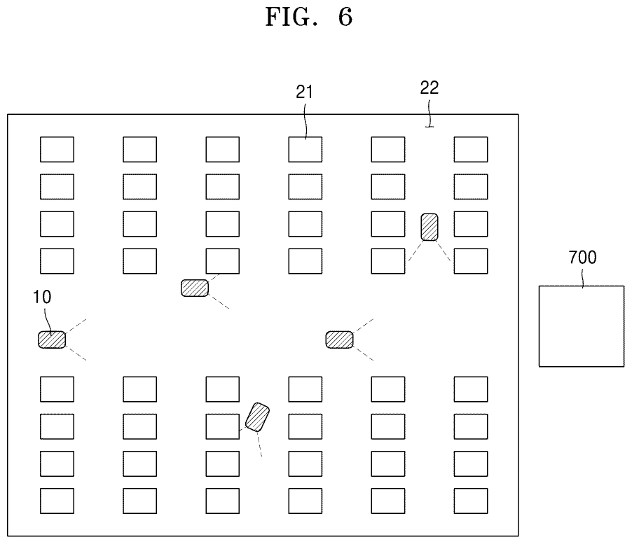

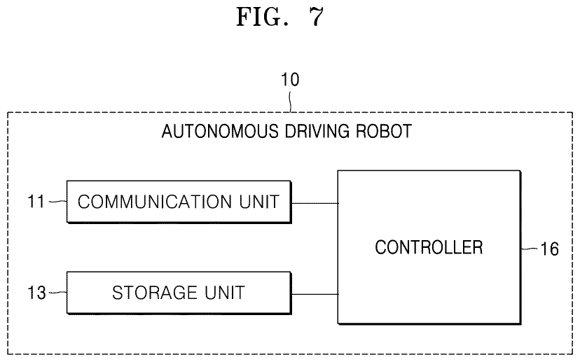

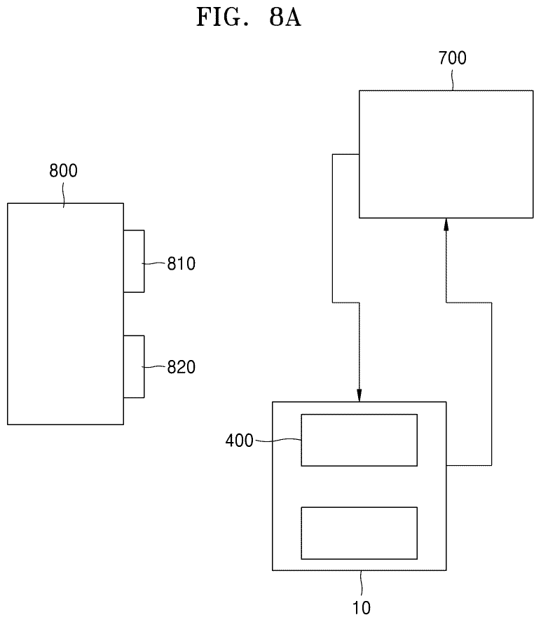

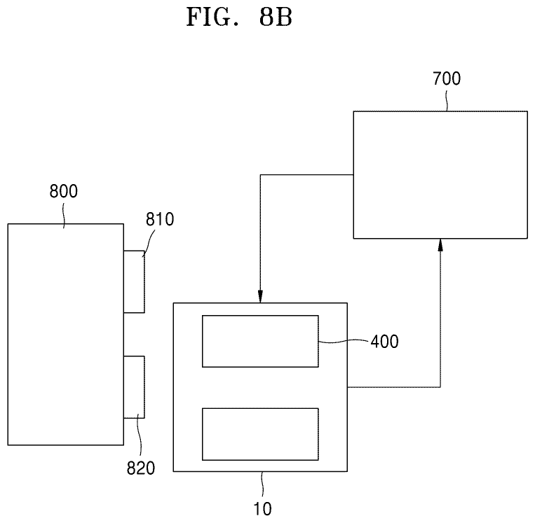

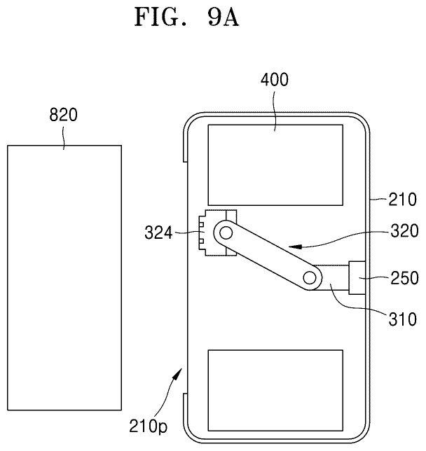

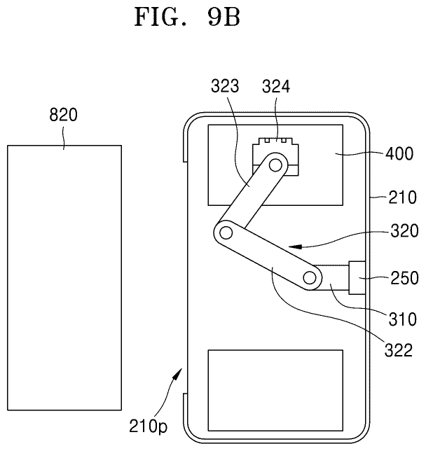

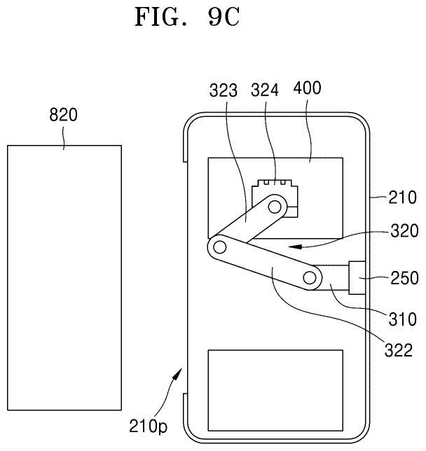

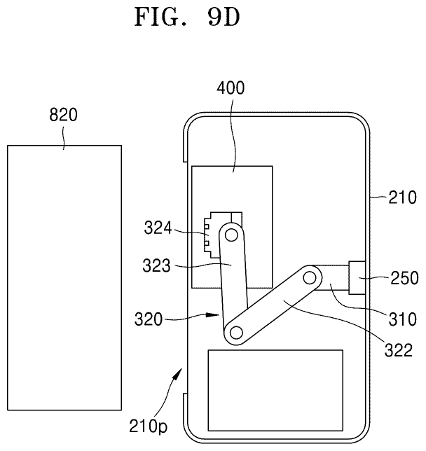

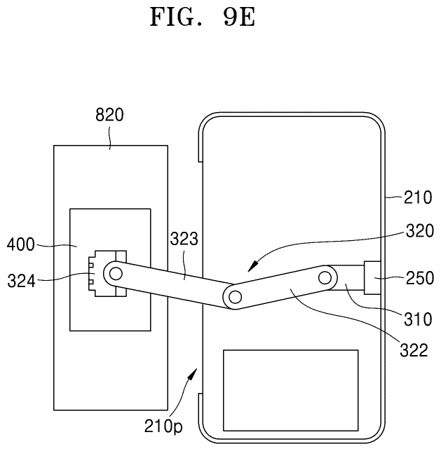

FIG. 5 is a flowchart showing an article transport method according to some embodiments of the inventive concept. FIG. 6 is a schematic view schematically showing a manufacturing line in which an autonomous driving robot according to some embodiments is applied. FIG. 7 is a block diagram schematically showing a method of controlling an autonomous driving robot, according to some embodiments. FIGS. 8A and 8B are schematic views for describing a method of transporting an article, according to some embodiments of the inventive concept. FIGS. 9A to 9E are schematic views for describing an article loading and unloading method by an autonomous driving robot according to some embodiments of the inventive concept. Hereinafter, an article transport method according to some embodiments is described in detail with reference to FIGS. 5 to 9E. Descriptions the same as those given with reference to FIGS. 1 to 4 will not be repeated.

Referring to FIGS. 5 to 8B, a central control system 700 transmits an operation instruction signal to an autonomous driving robot 10 (S110). According to some embodiments, the operation signal provided to the autonomous driving robot 10 may include or may be a signal for transmitting an article 400 between manufacturing equipment 21 or between manufacturing/production lines 22.

The manufacturing equipment 21 is to perform a process on a plurality of wafers and includes various types of processing devices that sequentially or repeatedly perform semiconductor manufacturing processes. For example, the manufacturing equipment 21 includes or may be deposition equipment, photolithography equipment, etching equipment, cleaning equipment, ion implantation equipment, diffusion equipment, etc. For example, the photolithography equipment is configured as a single manufacturing equipment 21 that includes a spinning unit for applying a photoresist on a plurality of wafers, a baking unit for curing the photoresist, an exposing unit for exposing the photoresist, a developing unit for developing the exposed photoresist, etc. This manufacturing equipment 21 is located in a workspace, e.g., a clean room so as to be managed free from dust or moisture in the air, and is sequentially installed in the workspace according to the order of unit processes. The workspace is divided into a manned workspace and an unmanned workspace. Since semiconductor manufacturing processes are generally repeated, a cassette, on which a plurality of wafers are mounted, needs to be moved to a certain position at a short distance or a long distance in many cases. Therefore, a manual conveyance device (manual conveyance cart) for loading cassettes may be transported by an operator in a manned workspace, and cassettes may be automatically transported by an automatic conveyance device in an unmanned workspace. Therefore, the manufacturing equipment 21 is sequentially arranged so as to correspond to the order of unit processes in a semiconductor production line.

The autonomous driving robot 10 may further include a communication unit 11, a storage unit 13, and a controller 16. The autonomous driving robot 10 may further include a battery capable of charging and discharging and a display (human machine interface (HMI)) displaying an operating state/status.

The communication unit 11 is connected to the central control system 700 via a wireless communication network to transmit and receive data. In addition, the communication unit 11 may transmit status data to and receive the status data from a workplace terminal and an elevator controller (a programmable logic controller (PLC)). The wireless communication network may include at least one of mobile communication (e.g., long term evolution (LTE)/5G) and wireless LAN (e.g., wireless fidelity (Wi-Fi)). The autonomous driving robot 10 may receive an operation instruction signal from the central control system 700 via the communication unit 11.

The storage unit 13 may store various programs and data for controlling the movement of the autonomous driving robot 10 according to an embodiment, and may store information generated according to the operation. The storage unit 13 may standardize and store a movement path for transporting articles by the autonomous driving robot 10 and the size information for each ID (code) of parts to be mounted. Here, the size information may include overall specifications of packages, containers (carriers), and pallets that accommodate corresponding parts.

The controller 16 may include or may be a central processing unit that controls the overall operation of each unit for controlling the autonomous driving robot 10. The controller 16 may be configured by hardware, firmware, software, or any combination thereof. For example, the controller 16 may include or may be a computing device, such as a workstation computer, a desktop computer, a laptop computer, and/or a tablet computer. The controller 16 may include or may be a simple controller, complex processors, such as microprocessors, central processing units (CPUs), and graphics processing units (GPUs), a processor configured by software, dedicated hardware, or firmware. The controller 16 may be configured by, for example, a general-purpose computer, or application-specific hardware, such as a digital signal processor (DSP), a field programmable gate array (FPGA), and an application specific integrated circuit (ASIC). The controller 16 may be configured by instructions which are stored on a machine-readable medium that may be read and executed by one or more processors. Here, the machine-readable medium may include or may be any mechanism for storing and/or transmitting information in a form readable by a machine (e.g., a computing device). For example, the machine-readable media may include or may be read only memory (ROM), random access memory (RAM), magnetic disk storage media, optical storage media, flash memory devices, electrical, optical, acoustic, or other forms of radio signals (e.g., carriers, infrared signals, digital signals, etc.), and any other signals.

After the autonomous driving robot 10 receives the operation instruction signal from the central control system 700, the autonomous driving robot 10 transmits a response signal to the central control system 700 (S130). The response signal includes or may be a response of the autonomous driving robot 10 to the operation instruction signal and the autonomous driving robot 10 may respond whether work is possible with the response signal. The autonomous driving robot 10 may transmit the response signal to the central control system 700 via the communication unit 11.

Referring to FIGS. 5 to 8B, when the autonomous driving robot 10 provides the central control system 700 with a signal indicating that the work is possible, the autonomous driving robot 10 moves in front of a manual port of a stocker (S150).

A stocker 800 may be configured to store a plurality of articles 400. The stocker 800 may include a manual port. The manual port may include a load port 820 and an unload port 810. The load port 820 may receive the article 400 loaded on the autonomous driving robot 10 and transport the same to the stocker 800. The unload port 810 may be configured to provide the autonomous driving robot 10 with the articles 400 received from the stocker 800. The autonomous driving robot 10 may move to the load port 820 of the manual port when receiving the operation instruction signal for delivering the article 400 to the stocker 800, and may move to the unload port 810 of the manual port when receiving the operation instruction signal for receiving the article 400 stored in the stocker 800 and delivering the article 400 to the manufacturing equipment 21.

In operation S150, the autonomous driving robot 10 stops after moving to a correct/predetermined position for exchanging the article 400 with the load port 820 or the unload port 810.

After the autonomous driving robot 10 stops at the correct/predetermined position, the autonomous driving robot 10 determines whether the article 400 is loaded or unloaded, and determines whether a loading or unloading is possible/ready. Determining whether the loading and/or unloading is possible/ready may include determining whether the article 400 is at a normal position and whether docking to the load port 820 and the unload port 810 is performed at the correct/predetermined positions.

Referring to FIGS. 5 and 9A to 9E, the autonomous driving robot 10 determines whether the loading and/or unloading is possible/ready. When it is determined that the article 400 can be loaded and/or unloaded, the autonomous driving robot 10 may start loading and unloading the article 400 (S170).

In operation S170, a SCARA arm 320 of the autonomous driving robot 10 may move in a vertical direction Z to adjust height in the vertical direction Z to a position corresponding to the article 400 to be targeted. Here, the SCARA arm 320 may be moved in the vertical direction Z by a linear actuator 310. After the movement of the SCARA arm 320 in the vertical direction Z is finished/completed, the SCARA arm 320 of the autonomous driving robot 10 is driven on an X-Y plane so that a hand 324 is coupled with the article 400 as illustrated in FIG. 9B. Here, the hand 324 may be moved to coordinates for docking on the article 400 by rotation of a first arm 322 and a second arm 323 on the X-Y plane. According to some embodiments, the hand 324 may be coupled with a docking portion that is located on the upper/top surface of the article 400.

Referring to FIGS. 9C and 9D, the hand 324 is coupled with the article 400 by a gripper, and then the SCARA arm 320 conveys the article 400 to a central portion of a housing 210. Subsequently, the SCARA arm 320 rotates the article 400 by 90 degrees on the X-Y plane through the rotation of the hand 324. Accordingly, the article 400 may be located near an opening 210p of the housing 210.

Referring to FIG. 9E, the SCARA arm 320 may convey the article 400 to the load port 820. Here, the hand 324 is moved to the load port 820 by rotation of the first arm 322 and the second arm 323 on the X-Y plane, and arrives at a loading position of the load port 820 for the article 400 to be loaded. Subsequently, the hand 324 uses/controls the gripper to release the article 400, and the article 400 may be put down at the loading position of the load port 820.

A process of conveying the article 400 stored in the stocker 800 to the autonomous driving robot 10 is the same as, substantially the same as or similar to the reverse process of FIGS. 9A to 9E, and thus, a description thereof is omitted.

Even though different figures illustrate variations of exemplary embodiments and different embodiments disclose different features from each other, these figures and embodiments are not necessarily intended to be mutually exclusive from each other. Rather, features depicted in different figures and/or described above in different embodiments can be combined with other features from other figures/embodiments to result in additional variations of embodiments, when taking the figures and related descriptions of embodiments as a whole into consideration. For example, components and/or features of different embodiments described above can be combined with components and/or features of other embodiments interchangeably or additionally to form additional embodiments unless the context indicates otherwise.

While the inventive concept has been particularly shown and described with reference to embodiments thereof, it will be understood that various changes in form and details may be made therein without departing from the spirit and scope of the following claims.

What is claimed is:

1. An autonomous driving robot comprising:
a storage unit comprising a housing, which provides a space for storing an article, and a shelf which is provided inside the housing and configured such that the article is loaded on the shelf;
a manipulator comprising a linear actuator which is provided inside the housing and extends in a vertical direction, and a selective compliance articulated robot arm (SCARA arm), which is coupled to the linear actuator; and
a transport unit coupled to the storage unit and configured to move the storage unit,
wherein a plurality of shelves are provided in the storage unit, some of the shelves are provided adjacent to one inner wall of the housing and spaced apart from each other in the vertical direction, and the other shelves are provided adjacent to another inner wall which faces the one inner wall and spaced apart from each other in the vertical direction, and
wherein the plurality of shelves extend in a horizontal direction toward a central axis of the housing, the central axis extending vertically at a center of the housing, and the plurality of shelves do not vertically overlap the central axis of the housing.

2. The autonomous driving robot of claim 1, wherein the transport unit is coupled to a bottom surface of the storage unit and configured to move on a floor.

3. The autonomous driving robot of claim 1, wherein the SCARA arm comprises a first arm and a second arm,
one end of the first arm is coupled to the linear actuator, and the other end of the first arm at the opposite end from the one end is coupled to one end of the second arm,
the first arm is configured to rotate, on an X-Y plane, about a first axis that is located at an end portion of the first arm adjacent to the one end of the first arm at which the first arm is coupled to the linear actuator, and
the second arm is configured to rotate, on an X-Y plane, about a second axis that is located at another end portion of the first arm adjacent to the other end of the first arm at which the second arm is coupled to the first arm.

4. The autonomous driving robot of claim 3, wherein the second arm is coupled to a bottom surface of the other end of the first arm.

5. The autonomous driving robot of claim 3, wherein the SCARA arm further comprises a hand that is coupled to the second arm, and
the hand is configured to be coupled to or detached from the article.

6. The autonomous driving robot of claim 1, wherein an opening is formed in one side of the housing,
the opening of the housing is configured such that the article is carried in or taken out, through the opening,
the housing comprises a pair of first side walls perpendicular to the side of the housing including the opening,
some of the shelves are arranged adjacent to one of the first side walls, and the other shelves are arranged adjacent to the other first side wall that faces the one of the first side walls, and
an area of each of the first side walls is smaller than an area of a side wall perpendicular to each of the first side walls.

7. The autonomous driving robot of claim 6, wherein the article has a door, and
the door of the article is configured to face the first side wall adjacent to the shelf when the article is loaded on the shelf.

8. The autonomous driving robot of claim 6, wherein four shelves are provided in the storage unit, and
two of the four shelves are provided on one of the first side walls of the housing, and the other two shelves are provided on the other first side wall that faces the one of the first side walls.

9. The autonomous driving robot of claim 1, wherein the storage unit further comprises a coupling member which is provided inside the housing and configured to connect the manipulator and the housing to each other.

10. The autonomous driving robot of claim 9, wherein the coupling member further comprises a frame which is coupled to one inner wall of the housing and configured to be coupled to and detached from the linear actuator.

11. The autonomous driving robot of claim 1, wherein the article comprises a front open unified pod (FOUP).

12. An autonomous driving robot comprising:
a storage unit comprising a housing, which provides a space for storing an article, and a shelf which is provided inside the housing and configured such that the article is loaded on the shelf;
a manipulator comprising a linear actuator, which is provided inside the housing and extends in a vertical direction, and a selective compliance articulated robot arm (SCARA arm), which is coupled to the linear actuator; and
a transport unit coupled to a bottom surface of the storage unit and configured to move on a floor,
wherein a plurality of shelves are provided in the storage unit, some of the shelves are provided adjacent to one inner wall of the housing and spaced apart from each other in the vertical direction, and the other shelves are provided adjacent to another inner wall which faces the one inner wall and spaced apart from each other in the vertical direction, and
the plurality of shelves extend horizontally toward a central axis of the housing, the central axis extending vertically at a center of the housing, and the plurality of shelves do not vertically overlap the central axis of the housing,
wherein the SCARA arm comprises at least two horizontal joints.

13. The autonomous driving robot of claim 1, wherein the SCARA arm comprises a first arm and a second arm,
one end of the first arm is coupled to the linear actuator, and the other end of the first arm at the opposite end from the one end is coupled to one end of the second arm,
the first arm is configured to rotate, on an X-Y plane, about a first axis that is located at an end portion adjacent to the one end of the first arm at which the first arm is coupled to the linear actuator, and
the second arm is configured to rotate, on an X-Y plane, about a second axis that is located at another end portion adjacent to the other end of the first arm at which the second arm is coupled to the first arm,
wherein the second arm is coupled to a bottom surface of the other end of the first arm.

14. The autonomous driving robot of claim 12, wherein the storage unit further comprises a coupling member which is provided inside the housing and configured to connect the manipulator and the housing to each other.

15. The autonomous driving robot of claim 12, wherein an opening is formed in one side of the housing,
the opening of the housing is configured such that the article is carried in or taken out through the opening,
the housing comprises a pair of first side walls perpendicular to the side of the housing in which the opening is formed,
some of the shelves are coupled to an inner surface of one of the first side walls, and the other shelves are coupled to an inner surface of the other first side wall that faces the one of the first side walls, and
an area of each of the first side walls is smaller than an area of a side wall perpendicular to each of the first side walls.

16. The autonomous driving robot of claim 15, wherein four shelves are provided in the storage unit, and
two of the four shelves are provided on one of the first side walls of the housing, and the other two shelves are provided on the other first side wall that faces the one of the first side walls.

17. The autonomous driving robot of claim 16, wherein the article comprises a door that is provided on one side surface of the article, and
the shelf is provided inside the housing such that the door is loaded on the shelf while facing the first side wall.

18. An article transport method comprising:
transmitting an operation instruction signal from a central control system to an autonomous driving robot, wherein the autonomous driving robot transmits a response signal to the central control system in response to the operation instruction signal;
moving the autonomous driving robot to a manual port of a stocker; and
starting loading or unloading of an article by the autonomous driving robot,
wherein the autonomous driving robot comprises:
a storage unit comprising a housing, which provides a space for storing an article, and a shelf, which is provided inside the housing and on which the article is loaded;
a manipulator comprising a linear actuator, which is provided inside the housing and extends in a vertical direction, and a selective compliance articulated robot arm (SCARA arm), which is coupled to the linear actuator; and
a transport unit coupled to a bottom surface of the storage unit and configured to move on a floor,
wherein the SCARA arm comprises at least two horizontal joints.

19. The article transport method of claim 18, wherein four shelves are provided in the storage unit, two of the four shelves are provided adjacent to one inner wall of the housing and spaced apart from each other in the vertical direction, and the other two shelves are provided adjacent to another inner wall of the housing, which faces the one inner wall, and spaced apart from each other in the vertical direction.

20. The article transport method of claim 18, wherein the SCARA arm comprises a first arm and a second arm,
one end of the first arm is coupled to the linear actuator, and the other end of the first arm at the opposite end from the one end is coupled to one end of the second arm,
the first arm rotates, on an X-Y plane, about a first axis that is located at an end portion adjacent to the one end of the first arm at which the first arm is coupled to the linear actuator, and
the second arm rotates, on an X-Y plane, about a second axis that is located at another end portion adjacent to the other end of the first arm at which the second arm is coupled to the first arm,
wherein the second arm is coupled to a bottom surface of the other end of the first arm.
